(19) United States
(12) Patent Application Publication
(10) Pub. No.: US 2008/0179824 A1
(43) Pub. Date: Jul. 31, 2008

(54) MEDIUM TRANSPORTING APPARATUS AND METHOD

(75) Inventor: Kaoru KOYAMA, Shioziri-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/020,413

(22) Filed: Jan. 25, 2008

(30) Foreign Application Priority Data
Jan. 26, 2007 (JP) 2007-016699

(51) Int. Cl. B65H 7/02; B41F 13/00

(52) U.S. Cl. 271/259; 270/1.01

(57) ABSTRACT

A medium transporting apparatus and method for transporting a medium in a transport direction is provided. The medium transporting apparatus includes an upstream transport roller and a downstream transport roller, provided respectively upstream and downstream in the transport direction, for transporting the medium on an intermittent basis by the collective rotation of the rollers; and a controller for starting and interrupting the rotation of the upstream transport roller and the downstream transport roller in an alternating manner over a plurality of periods of time during the intermittent transport of the medium, wherein during the first rotation period of the upstream transport roller and the downstream transport roller, the controller controls the amount of transport of the medium by the upstream transport roller so as to be greater than the amount of transport of the medium by the downstream transport roller, and wherein during the second and later rotation periods of the upstream transport roller and the downstream transport roller, the controller controls the amount of transport of the medium by the upstream transport roller so as to be the same as the amount of transport of the medium by the downstream transport roller.

### BACKGROUND

1. Technical Field

The present invention relates to a medium transporting apparatus and method.

2. Related Art

A medium transporting apparatus for transporting a medium in a transport direction is well known. The medium transporting apparatus includes a plurality of rollers for transporting the medium, for example, an upstream transport roller and a downstream transport roller, provided respectively upstream and downstream in the transport direction.

In such a medium transporting apparatus, in order to shorten a medium transport time, the medium is transported on an intermittent basis by the collective rotation of the upstream transport roller and the downstream transport roller. During the intermittent transport of the medium, the rotation of the upstream transport roller and the downstream transport roller is controlled to be started and interrupted in an alternating manner over a plurality of periods of time.

JP-A-2003-72964 and JP-A-2006-117385 are examples of the related art.

For smooth intermittent transport of the medium, the upstream transport roller and the downstream transport roller transport the medium on an intermittent basis while loosening the medium. Inside the medium transporting apparatus, there is a mechanism, in which in order to loosen the medium, during rotation of the upstream transport roller and the downstream transport roller, the amount of transport of the medium by the upstream transport roller (i.e., the amount of rotation of the upstream transport roller) is controlled so as to be greater than the amount of transport of the medium of the downstream transport roller (i.e., the amount of rotation of the downstream transport roller).

However, when the medium transporting apparatus continuously starts and interrupts the rotation of the upstream transport roller and the downstream transport roller over a plurality of periods of time in the state in which the amount of transport of the medium by the upstream transport roller is greater than the amount of transport of the medium by the downstream transport roller, the amount of looseness of the medium increases accumulatively. If the amount of looseness of the medium accumulates excessively, the medium makes contact with other members within the medium transporting apparatus, other than the upstream transport roller and the downstream transport roller, thereby damaging the members or the medium or generating abnormal sound at the time of the contact. In this way, when the amount of looseness of the medium is excessively large, the medium is not properly transported on an intermittent basis.

### SUMMARY

An advantage of some aspects of the invention is that it provides a medium transporting apparatus and method capable of properly transporting a medium on an intermittent basis.

According to an aspect of the invention, there is provided medium transporting apparatus for transporting a medium in a transport direction, including: an upstream transport roller and a downstream transport roller, provided respectively upstream and downstream in the transport direction, for transporting the medium on an intermittent basis by the collective rotation of the rollers; and a control portion for starting and interrupting the rotation of the upstream transport roller and the downstream transport roller in an alternating manner over a plurality of periods of time during the intermittent transport of the medium, wherein during the first rotation period of the upstream transport roller and the downstream transport roller, the control portion controls the amount of transport of the medium by the upstream transport roller so as to be greater than the amount of transport of the medium by the downstream transport roller, and wherein during the second and later rotation periods of the upstream transport roller and the downstream transport roller, the control portion controls the amount of transport of the medium by the upstream transport roller so as to be the same as the amount of transport of the medium by the downstream transport roller.

These and other features of the invention will be more fully apparent from the following description and accompanying drawings.

### BRIEF DESCRIPTION OF THE DRAWINGS

The invention will be described with reference to the accompanying drawings, wherein like numbers reference like elements.

FIG. 1 is a block diagram showing the entire structure of a printer 1.

FIG. 2 is a schematic diagram showing a simplified structure of a main portion of the printer 1.

FIG. 3 is a schematic diagram showing the structure of a driving portion of a transport unit 20.

FIGS. 4A to 4D are schematic diagram for describing intermittent transport of a sheet S.

FIG. 5 is a flowchart for describing the process of controlling the rotation of a feed roller 22 and a conveying roller 23.

FIG. 6 is a flowchart for describing the process of controlling the rotation of a feed roller 22 and a conveying roller 23.

### DESCRIPTION OF EXEMPLARY EMBODIMENTS

The following aspects of the invention will be apparent from the following description and accompanying drawings.

According to one aspect of the invention, there is provided a medium transporting apparatus for transporting a medium in a transport direction, including: an upstream transport roller and a downstream transport roller, provided respectively upstream and downstream in the transport direction, for transporting the medium on an intermittent basis by the collective rotation of the rollers; and a control portion for starting and interrupting the rotation of the upstream transport roller and the downstream transport roller in an alternating manner over a plurality of periods of time during the intermittent transport of the medium, wherein during the first rotation period of the upstream transport roller and the downstream transport roller, the control portion controls the amount of transport of the medium by the upstream transport roller so as to be greater than the amount of transport of the medium by the downstream transport roller, and wherein during the second and later rotation periods of the upstream transport roller and the downstream transport roller, the control portion controls the amount of transport of the medium by the upstream transport roller so as to be the same as the amount of transport of the medium by the downstream transport roller.

According to the medium transporting apparatus, when the medium is transported by the upstream transport roller and the downstream transport roller on an intermittent basis, the amount of looseness of the medium would not increase accumulatively. Therefore, it is possible to properly transport the medium on an intermittent basis.

In the medium transporting apparatus, during the second and later rotation periods of the upstream transport roller and the downstream transport roller, the control portion may start the rotation of the upstream transport roller before the downstream transport roller starts rotating. In such a case, it is possible to perform the intermittent transport of the medium in a more effective manner.

In the medium transporting apparatus, during the second and later rotation periods of the upstream transport roller and the downstream transport roller, the control portion may stop the rotation of the upstream transport roller after the downstream transport roller stops rotating. In such a case, it is possible to prevent or suppress generation of abnormal sound resulting from the medium pulled by the downstream transport roller.

In the medium transporting apparatus, during the first rotation period of the upstream transport roller and the downstream transport roller, the control portion may start the rotation of the upstream transport roller before the downstream transport roller starts rotating and may stop the rotation of the upstream transport roller after the downstream transport roller stops rotating. In such a case, it is possible to loosen the medium in a secure manner and to prevent or suppress generation of abnormal sound resulting from the medium pulled by the downstream transport roller.

In the medium transporting apparatus, the medium transporting apparatus may be a printing apparatus that prints images on the medium, and the printing apparatus may include an ink ejecting portion for ejecting ink onto the medium, provided on the downstream side of the downstream transport roller in the transport direction so as to be opposed to the medium being transported by the upstream transport roller and the downstream transport roller on an intermittent basis. In such a case, it is possible to more effectively provide an advantage of properly transporting the medium on an intermittent basis.

According to another aspect of the invention, there is provided a medium transporting method, in which when an upstream transport roller and a downstream transport roller, provided respectively upstream and downstream in a transport direction, transport a medium on an intermittent basis by the collective rotation of the rollers, the rotation of the downstream transport roller and the upstream transport roller is started and interrupted in an alternating manner over a plurality of periods of time. The method includes: during the first rotation period of the upstream transport roller and the downstream transport roller, controlling the amount of transport of the medium by the upstream transport roller so as to be greater than the amount of transport of the medium by the downstream transport roller; and during the second and later rotation periods of the upstream transport roller and the downstream transport roller, controlling the amount of transport of the medium by the upstream transport roller so as to be the same as the amount of transport of the medium by the downstream transport roller.

According to the medium transporting method, when the medium is transported by the upstream transport roller and the downstream transport roller on an intermittent basis, the amount of looseness of the medium would not increase accumulatively. Therefore, it is possible to properly transport the medium on an intermittent basis.

### Structure of Printer 1

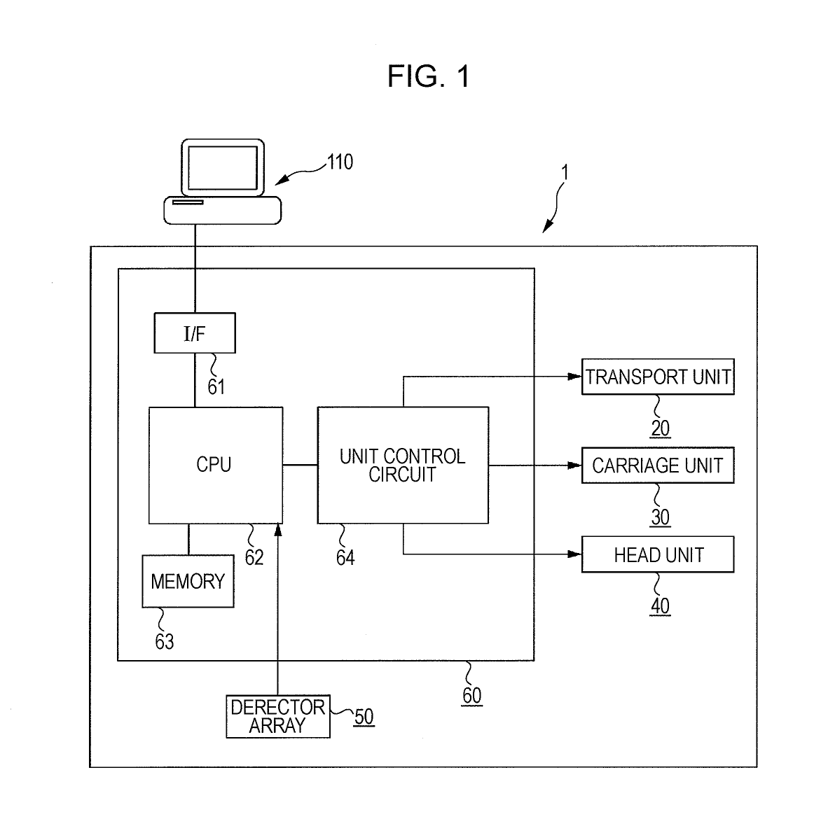

FIG. 1 is a block diagram showing the entire structure of an ink jet printer (hereinafter also referred to as a printer 1) as an example of a medium transporting apparatus. Hereinafter, a basic structure of the printer 1 will be described.

The printer 1 is a printing apparatus that prints images on a medium (for example, a sheet S). The printer 1 includes a transport unit 20, a carriage unit 30, a head unit 40 as an example of an ink ejecting portion, a detector array 50, and a controller 60 as an example of a control portion. Upon receiving print data from an external computer 110, the printer 1 controls the transport unit 20, the carriage unit 30, and the head unit 40 by means of the controller 60. The controller 60 controls the units based on the print data received from the computer 110 to print images on the sheet S. The internal state of the printer 1 is monitored by the detector array 50, and the detection results of the detector array 50 are output to the controller 60. The controller 60 controls the units based on the detection results output from the detector array 50.

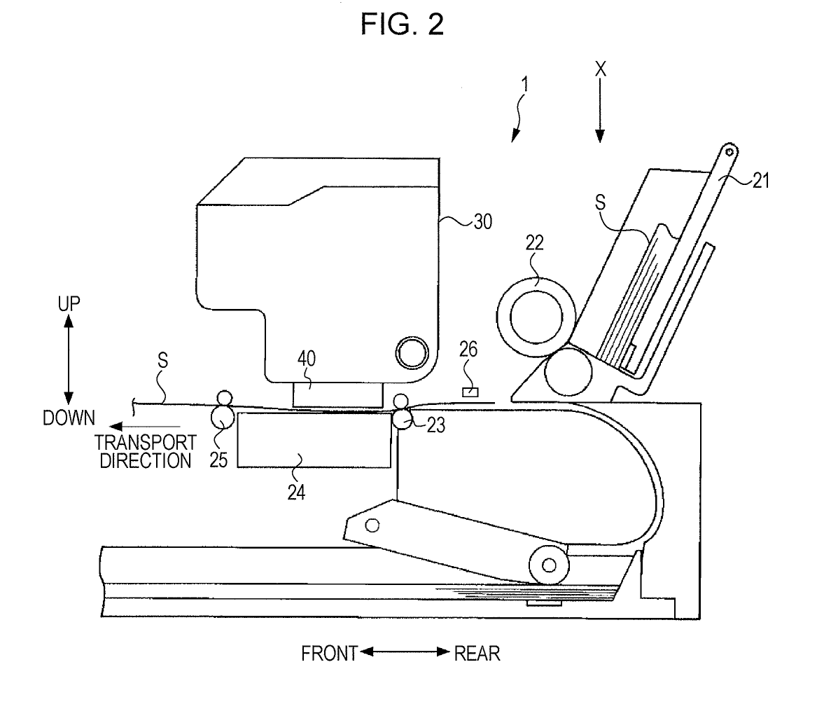

The transport unit 20 is provided for transporting the sheet S in a predetermined transport direction (see FIG. 2) by means of a plurality of rollers provided in a transport path. The transport unit 20 can transport various types of the sheet S such as plain paper or specific paper. The detailed structure of the transport unit 20 will be described later.

The carriage unit 30 is provided for moving an ink ejecting head in a predetermined direction. The head unit 40 is provided on the carriage unit 30, for ejecting ink onto the sheet S by means of a head having a plurality of nozzles. The detector array 50 includes sensors of various types.

The controller 60 is a control unit (a control portion) for controlling the printer 1. The controller 60 includes an interface portion 61, a CPU 62, a memory 63, and a unit control circuit 64. The interface portion 61 performs data communication between the computer 110 and the printer 1. The CPU 62 is an arithmetic processing unit for controlling the entire operations of the printer 1. The memory 63 is provided to provide an area for storing programs of the CPU 62 or a work area. The memory 63 includes a storage element such as a RAM (an example of volatile memory) or a ROM (an example of nonvolatile memory). The CPU 62 controls the units by means of the unit control circuit 64 in accordance with the programs stored in the memory 63.

### Detailed Structure of Transport Unit 20

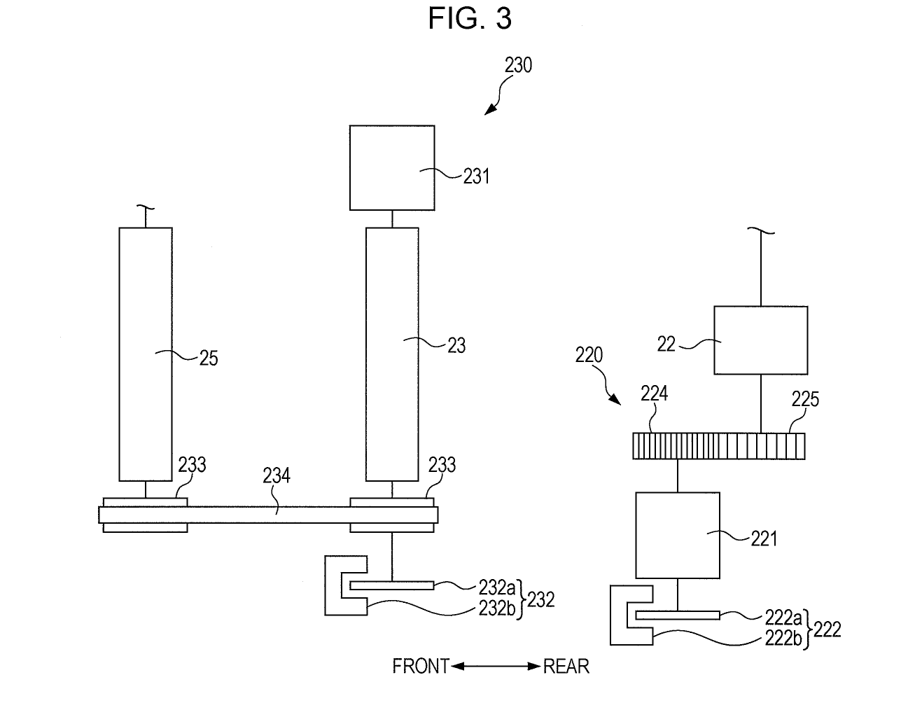

The detailed structure of the transport unit 20 will be described with reference to FIGS. 2 and 3. FIG. 2 is a schematic diagram showing a simplified structure of a main portion of the printer 1. FIG. 3 is a schematic diagram showing the structure of the transport unit 20, seen in the direction of the arrow X in FIG. 2. In FIG. 2, the up-down direction and the front-rear direction are represented by the respective bidirectional arrows. In FIG. 3, the front-rear direction is represented by the bidirectional arrow.

The transport unit 20 is provided for transporting the sheet S in a predetermined transport direction by means of a plurality of rollers. As shown in FIG. 2, the transport unit 20 includes a feed hopper 21, a feed roller 22, as an example of an upstream transport roller, provided upstream in the transport direction, a conveying roller 23, as an example of a downstream transport roller, provided downstream in the transport direction, a platen 24, a discharge roller 25, and a sheet detecting sensor 26.

The feed hopper 21 is a member for supporting the sheet S in stack. The feed roller 22 is a pair of rollers, for feeding (transporting) the sheet S set on the feed hopper 21 to the inside of the printer 1. Specifically, the sheet S is transported by being sandwiched between the pair of rollers of the feed roller 22. The conveying roller 23 is a pair of rollers, for conveying the sheet S transported by the feed roller 22 to a printable region (the head unit 40). Specifically, the sheet S is transported by being sandwiched between the pair of rollers of the conveying roller 23. The platen 24 is provided for supporting the sheet S in printing. The discharge roller 25 is provided for discharging the sheet S to the outside of the printer 1. The sheet detecting sensor 26 is provided between the feed roller 22 and the conveying roller 23 in the transport direction, for detecting passage of the sheet S.

In the present embodiment, the feed roller 22 and the conveying roller 23 are configured to transport the sheet S on an intermittent basis by the collective rotation of the rollers 22 and 23. The head unit 40 (FIG. 2) provided on the downstream side of the conveying roller 23 in the transport direction ejects ink onto the sheet S by being opposed to the sheet S being transported by the feed roller 22 and the conveying roller 23 on an intermittent basis.

As shown in FIG. 3, the transport unit 20 includes, as a driving portion, a feeder driving portion 220 for driving the feed roller 22, and a conveyance driving portion 230 for driving the conveying roller 23 and the discharge roller 25.

The feeder driving portion 220 includes a feeder motor 221, a motor-side gear 224, and a roller-side gear 225, for driving the feed roller 22. The feeder motor 221 receives driving current and drives the feed roller 22. The feeder motor 221 is a DC motor. In the present embodiment, as a control method of the feeder motor 221, a pulse-width-modulation (PWM) control, in which a pulse width of power pulses supplied to the feeder motor 221 is varied, and a proportional-integral-differential (PID) control, in which a proportional control, an integral control, and a differential control are combined with each other, are employed. The motor-side gear 224 and the roller-side gear 225 are provided for transmitting a driving force of the feeder motor 221 to the feed roller 22 by rotating in the state that their respective toothed surfaces are contacted.

The conveyance driving portion 230 includes a conveyance motor 231, a pulley 233, and a belt 234, for driving the conveying roller 23 and the discharge roller 25. The conveyance motor 231 is fitted to the shaft of the conveying roller 23 at one end in the axial direction of the conveying roller 23. The conveyance motor 231 receives driving current and drives the conveying roller 23 and the discharge roller 25. The conveyance motor 231 is a DC motor. In the present embodiment, as a control method of the conveyance motor 231, a PWM control and a PID control are employed in a manner similar to the case of the feeder motor 221. The pulley 233 and the belt 234 are provided at the other end in the axial direction of the conveying roller 23, for transmitting a driving force transmitted to the conveying roller 23 from the conveyance motor 231 to the discharge roller 25.

The driving portion of the transport unit 20 is provided with a feeder motor encoder 222 for detecting the amount of rotation of the feeder motor 221 and a conveying roller encoder 232 for detecting the amount of rotation (a driving amount) of the conveying roller 23. The encoders 222 and 232 constitute the detector array 50 (FIG. 1).

The feeder motor encoder 222 includes a rotary scaler 222a that is fixed to the shaft of the feeder motor 221 and a photosensor 222b that has a light emitting element (not shown) and a light receiving element (not shown). When the output signal of the photosensor 222b is input to the controller 60, the amount of rotation of the feeder motor 221 is detected.

The conveyance roller encoder 232 includes a rotary scaler 232a that is fixed to the shaft of the conveying roller 23 and a photosensor 232b that has a light emitting element (not shown) and a light receiving element (not shown). Similar to the case of the feeder motor encoder 222, when the output signal of the photosensor 232b is input to the controller 60, the amount of rotation (the driving amount) of the conveying roller 23 is detected.

### Intermittent Transport of Sheet

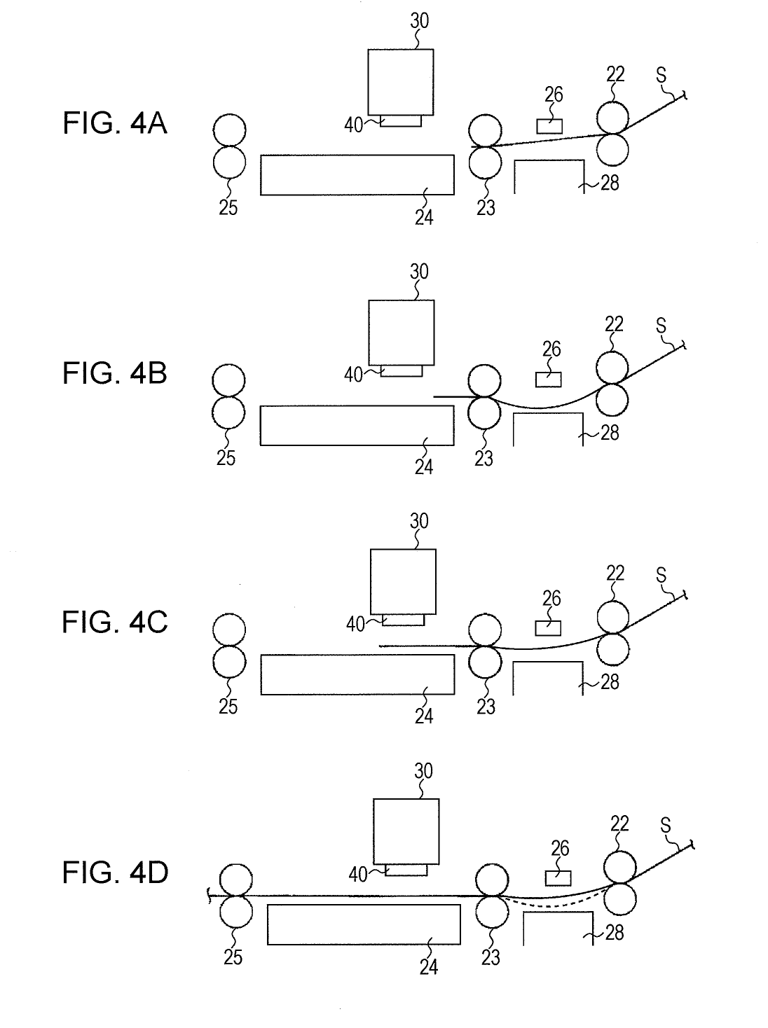

As described above, the printer 1 prints images on the sheet S being transported on an intermittent basis. However, during the intermittent transport of the sheet S, the rotation of the feed roller 22 and the conveying roller 23 is started and interrupted in an alternating manner over a plurality of periods of time. This will be described in detail with reference to FIGS. 4A to 4D.

FIGS. 4A to 4D are schematic diagrams for describing the intermittent transport of the sheet S. FIG. 4A shows the state of the sheet S immediately before the intermittent transport is started. FIG. 4B shows the sate of the sheet S when of the feed roller 22 and the conveying roller 23 start rotating during the first rotation period. FIG. 4C shows the state of the sheet S when the first rotation period ends. FIG. 4D shows the states of the sheet S when the rotation of the feed roller 22 and the conveying roller 23 is started and interrupted during the second and later rotation and interrupt periods.

For the printer 1 to print images on the sheet S, first, as shown in FIG. 4A, the sheet S set on the feed hopper 21 is transported to the conveying roller 23 by the feed roller 22 driven by the feeder motor 221.

The sheet S transported to the conveying roller 23 is transported on an intermittent basis when the rotation of the feed roller 22 and the conveying roller 23 driven by the conveyance motor 231 is started and interrupted in a repeated manner. That is, the sheet S transported to the conveying roller 23 is transported to a position opposite the head unit 40 as shown in FIG. 4B when the feed roller 22 and the conveying roller 23 rotate for the first rotation period. Then, the transport of the sheet S stops in the state shown in FIG. 4C when the feed roller 22 and the conveying roller 23 stop rotating after the first rotation period. The sheet S transported to the position opposite the head unit 40 is transported further as shown in FIG. 4D when the rotation of the feed roller 22 and the conveying roller 23 is started and interrupted during the second and later rotation and interrupt periods.

In the present embodiment, for smooth intermittent transport of the sheet S, the printer 1 loosens the sheet S between the feed roller 22 and the conveying roller 23 as shown in FIGS. 4B to 4D in the transport and standby modes of the intermittent transport (during the rotation and interrupt periods of the feed roller 22 and the conveying roller 23). In FIG. 4D, the solid line represents the looseness of the sheet S in the standby mode, and the dotted line represents the looseness of the sheet S in the transport mode.

When the sheet S is in the standby mode (for example, FIG. 4C) of the intermitted transport, ink is ejected onto the sheet S from the head of the head unit 40. By repeating the operation of transporting the sheet S on an intermittent basis and the operation of ejecting ink onto the sheet S in the standby mode, images are finally printed onto the sheet S.

### Rotation Control of Feed Roller and Conveying Roller

As described above, during the intermittent transport, the printer 1 of the present embodiment starts and interrupts the rotation of the feed roller 22 and the conveying roller 23 in an alternating manner over a plurality of periods of time. In the following descriptions, the number of periods is assumed to be four in order to simplify the descriptions. For each of four rotation periods, the rotation of the feed roller 22 and the conveying roller 23 is controlled in order to loosen the sheet S. A process of controlling the rotation will be described below.

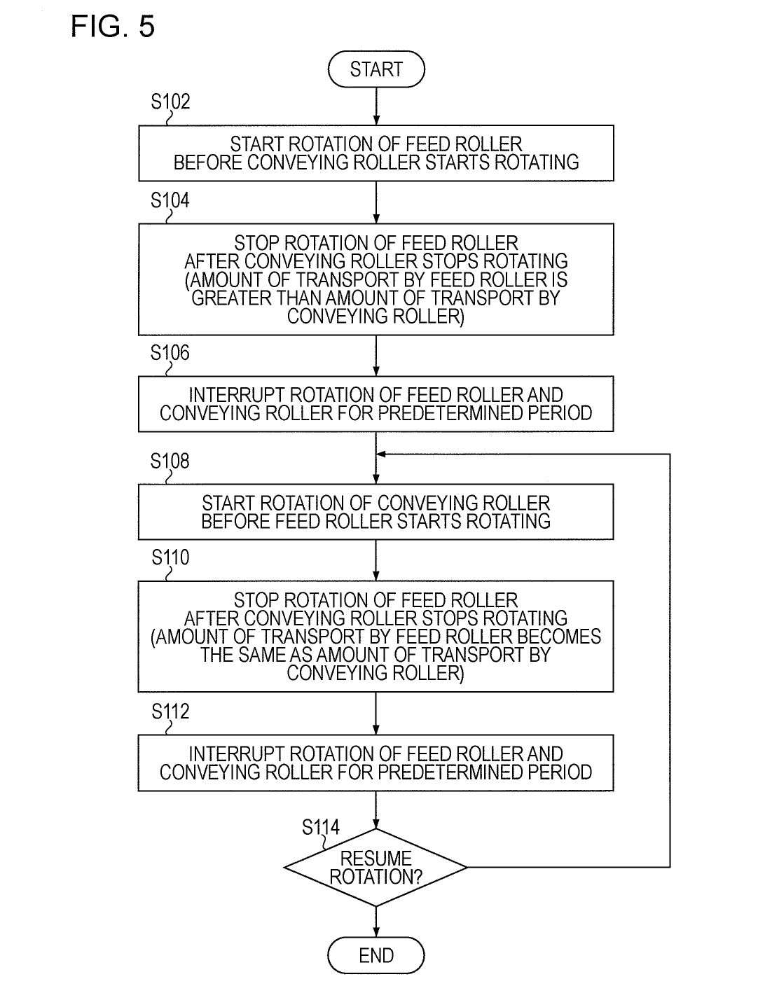

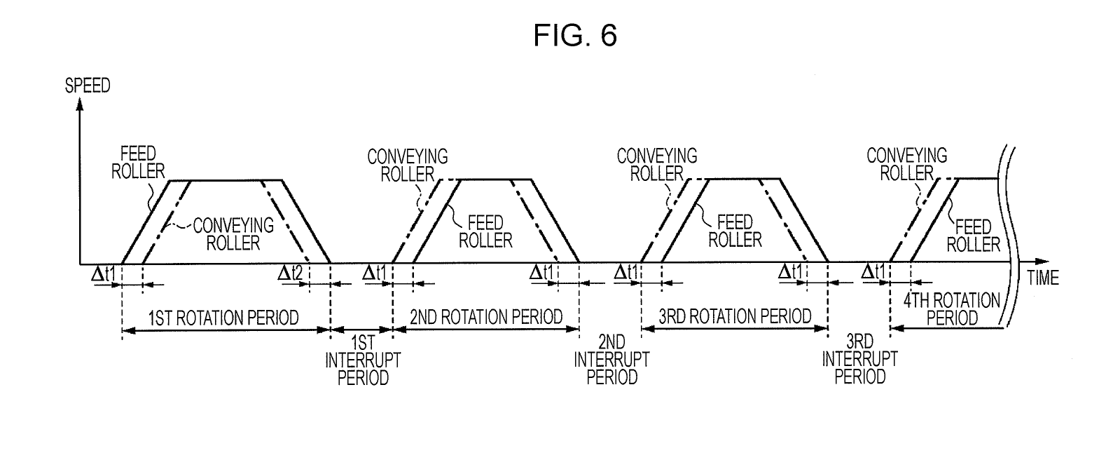

FIG. 5 is a flowchart for describing the process of controlling the rotation of the feed roller 22 and the conveying roller 23. FIG. 6 is a flowchart for describing the process of controlling the rotation of the feed roller 22 and the conveying roller 23. The process starts from the state in which the sheet S is transported by the feed roller 22 to the conveying roller 23 as shown in FIG. 4A and in which the feeder motor 221 is not rotating. When the sheet S is placed in the state shown in FIG. 4A, the sheet S is not loosened between the feed roller 22 and the conveying roller 23 in the transport direction or the sheet S is tightened.

When the present process is executed, the operations of the printer 1 are mainly carried out by the controller 60. Specifically, in the present embodiment, the operations are carried out when the CPU 62 processes the programs stored in the memory 63. The programs are constructed from codes for executing various operations described later.

First, the controller 60 starts the rotation of the feed roller 22 for the first rotation period of the intermittent transport by supplying driving current to the feeder motor 221 and starts the rotation of the conveying roller 23 for the first rotation period of the intermittent transport by supplying driving current to the conveyance motor 231. As a result, the sheet S is transported as shown in FIG. 4B by the collective rotation of the feed roller 22 and the conveying roller 23. In this case, as shown in FIG. 6, the respective rotation speeds of the feed roller 22 and the conveying roller 23 is controlled based on the PWM and PID control such that the speed is accelerated up to an upper limit (constant speed) and is thereafter decelerated until the rollers stop rotating. The same speed control strategy is applied to the second and later rotation periods. The same upper limit is applied to the feed roller 22 and the conveying roller 23. The times required for accelerating the feed roller 22 and the conveying roller 23 are substantially the same. The times required for decelerating the feed roller 22 and the conveying roller 23 are substantially the same.

However, during the first rotation period, the rotation start time and the rotation stop time of the feed roller 22 are different from the rotation start time and the rotation stop time of the conveying roller 23 (steps S102 and S104). Specifically, as shown in FIG. 6, during the first rotation period, the controller 60 starts the rotation of the feed roller 22 with a leading time of Δt1 before the conveying roller 23 starts rotating, and stops the rotation of the feed roller 22 with a delay time of Δt2 after the conveying roller 23 stops rotating. With such a rotation control, the amount of transport of the sheet S by the feed roller 22 (i.e., the amount of rotation of the feed roller 22) during the first rotation period is greater than the amount of transport of the sheet S by the conveying roller 23 (i.e., the amount of rotation of the conveying roller 23) during the first rotation period.

As a result of the rotation control, during the first rotation period, the state of looseness of the sheet S between the feed roller 22 and the conveying roller 23 in the transport direction varies. Until the conveying roller 23 starts rotating after the rotation of the feed roller 22 is started, the sheet S is transported by only the feed roller 22 disposed upstream in the transport direction. Therefore, the amount of looseness of the sheet S between the feed roller 22 and the conveying roller 23 increases. Even after the rotation of the conveying roller 23 is started, the amount of looseness of the sheet S increases when the conveying roller 23 is in the acceleration mode. When the conveying roller 23 rotates at the constant speed, the amount of looseness of the sheet S does not increase because the speeds of the two rollers are the same. Until the two rollers stop rotating after the conveying roller 23 enters the deceleration mode, the amount of looseness of the sheet S is further increased. In this way, during the first rotation period, the amount of looseness of the sheet S between the feed roller 22 and the conveying roller 23 is increased.

The effect of the looseness of the sheet S between the feed roller 22 and the conveying roller 23 in the transport direction when the sheet S is transported on an intermittent basis will be described. For the conveying roller 23 to transport the sheet S, it is preferable that the sheet S is loosed between the feed roller 22 and the conveying roller 23 in the transport direction. As described above, the feed roller 22 and the conveying roller 23 transport the sheet S by sandwiching the sheet S between the respective pairs of rollers. If the sheet S is not loosened, since the sheet S is sandwiched between the pair of rollers of the feed roller 22, a backward tension acts on the sheet S in the direction from the conveying roller 23 to the feed roller 22. It becomes difficult for the conveying roller 23 to transport the sheet S. On the other hand, if the sheet S is loosened, the backward tension hardly acts on the sheet S. Thus, the conveying roller 23 can properly transport the sheet S. In the present embodiment, in order to make the sheet S loosened during the rotation of the conveying roller 23, the controller 60 starts the rotation of the feed roller 22 before the conveying roller 23 starts rotating (step S102).

As described above, the controller 60 stops the rotation of the feed roller 22 after the conveying roller 23 stops rotating (step S104). With this, it is possible to prevent or suppress generation of abnormal sound resulting from the sheet S pulled by the conveying roller 23. Between the feed roller 22 and the conveying roller 23 in the transport direction, the feed roller 22 transports the sheet S in a manner that the sheet S is pushed by the pair of rollers. On the other hand, the conveying roller 23 transports the sheet S in a manner that the sheet S is pulled by the pair of rollers. In such a case, if the rotation of the conveying roller 23 stops after the feed roller 22 stops rotating, when the conveying roller 23 stops rotating, it is likely that an abnormal sound is generated resulting from the sheet S pulled by the conveying roller 23. In addition, when the sheet S is pulled by the conveying roller 23, a problem of misalignment of the sheet S may also be caused in addition to the problem of the abnormal sound. On the other hand, when the rotation of the feed roller 22 stops after the conveying roller 23 stops rotating, the sheet S is not pulled by the conveying roller 23 because the rotation of the conveying roller 23 has been interrupted. Therefore, it is not likely that the abnormal sound or the misalignment of the sheet S is generated or caused.

Referring to the flowchart of FIG. 5, the process of controlling the rotation of the feed roller 22 and the conveying roller 23 will be described. The controller 60 interrupts the rotation of the feed roller 22 and the conveying roller 23 for a predetermined period after the feed roller 22 and the conveying roller 23 stop rotating (step S106). During the predetermined period, the sheet S is in the standby mode and in the loosened state (FIG. 4C). Then, the controller 60 operates the head unit 40 disposed opposite the sheet S to eject ink onto the sheet S in the standby mode.

Next, the controller 60 starts the rotation of the feed roller 22 for the second rotation period of the intermittent transport by supplying driving current to the feeder motor 221 and starts the rotation of the conveying roller 23 for the second rotation period of the intermittent transport by supplying driving current to the conveyance motor 231. As a result, the sheet S is transported further by the collective rotation of the feed roller 22 and the conveying roller 23 (FIG. 4D).

However, during the second rotation period, the rotation start time and the rotation stop time of the feed roller 22 are different from the rotation start time and the rotation stop time of the conveying roller 23 (steps S108 and S110). Specifically, as shown in FIG. 6, in a manner different from the case of the first rotation period, during the second rotation period, the controller 60 starts the rotation of the conveying roller 23 with a leading time of Δt1 before the feed roller 22 starts rotating. Moreover, in a manner different from the case of the first rotation period, during the second rotation period, the controller 60 stops the rotation of the conveying roller 23 with a delay time of Δt1 after the feed roller 22 stops rotating. With such a rotation control, the amount of transport of the sheet S by the feed roller 22 during the second rotation period becomes the same as the amount of transport of the sheet S by the conveying roller 23 during the second rotation period.

As a result of the rotation control, during the second rotation period, the state of looseness of the sheet S between the feed roller 22 and the conveying roller 23 in the transport direction varies. Until the feed roller 22 starts rotating after the rotation of the conveying roller 23 is started, in a manner different from the case of the first rotation period, the sheet S is transported by only the conveying roller 23 disposed downstream in the transport direction. Therefore, the amount of looseness of the sheet S decreases. Even after the rotation of the feed roller 22 is started, the amount of looseness of the sheet S decreases when the feed roller 22 is in the acceleration mode. When the feed roller 22 rotates at the constant speed, the amount of looseness of the sheet S does not decrease because the speeds of the two rollers are the same. In the present embodiment, because the amount of decrease in the looseness of the sheet S until the feed roller 22 rotates at the constant speed is smaller than the amount of looseness of the sheet S when the first rotation period ends, the state of looseness of the sheet S is maintained. Until the two rollers stop rotating after the conveying roller 23 enters the deceleration mode, the amount of looseness of the sheet S increases. However, the amount of increase in the looseness of the sheet S must be smaller than the amount of looseness of the sheet S when the conveying roller 23 starts rotating. In this way, the amount of looseness of the sheet S decreases until the feed roller 22 and the conveying roller 23 rotate at the constant speed, while the amount of looseness of the sheet S increases after the conveying roller 23 enters the deceleration mode.

As described above, during the second rotation period, the amount of transport of the sheet S by the feed roller 22 is the same as the amount of transport of the sheet S by the conveying roller 23. Therefore, the amount of looseness of the sheet S when the conveying roller 23 stops rotating becomes the same as the amount of looseness of the sheet S when the feed roller 22 starts rotating. In other words, the amount of looseness of the sheet S when the conveying roller 23 stops rotating becomes the same as the amount of looseness of the sheet S when the first rotation period ends.

Returning to the flowchart of FIG. 5, description of the process of controlling the rotation of the feed roller 22 and the conveying roller 23 will be continued. The controller 60 interrupts the rotation of the feed roller 22 and the conveying roller 23 for a predetermined period after the feed roller 22 and the conveying roller 23 stop rotating (step S112). During the predetermined period, the sheet S is in the standby mode and in the loosened state. Then, the controller 60 operates again the head unit 40 disposed opposite the sheet S to eject ink onto the sheet S in the standby mode.

Next, in a manner similar to the case of the second rotation period, during the third and fourth rotation periods (step S114: Yes), the controller 60 starts and interrupts the rotation of the feed roller 22 and the conveying roller 23 in a repeated manner (step S108 to S112). That is, during the third and fourth rotation periods, the controller 60 starts the rotation of the conveying roller 23 before the feed roller 22 starts rotating, and stops the rotation of the conveying roller 23 after the feed roller 22 stops rotating. During the third and fourth rotation periods, the sheet S is transported on an intermittent basis by the collective rotation of the feed roller 22 and the conveying roller 23 (FIG. 4D).

In a manner similar to the case of the second rotation period, during the third and fourth rotation periods, the amount of looseness of the sheet S decreases until the feed roller 22 and the conveying roller 23 rotate at the constant speed, while the amount of looseness of the sheet S increases after the conveying roller 23 enters the deceleration mode. In addition, in a manner similar to the case of the second rotation period, during the third and fourth rotation periods, the amount of transport of the sheet S by the feed roller 22 is the same as the amount of transport of the sheet S by the conveying roller 23. Therefore, the amount of looseness of the sheet S when the conveying roller 23 stops rotating becomes the same as the amount of looseness of the sheet S when the feed roller 22 starts rotating.

When the fourth rotation period ends, the controller 60 stops the intermittent transport of the sheet S (step S114: No). Then, the sheet S is discharged by the discharge roller 25 to the outside of the printer 1.

### Effectiveness of Printer 1

As described above, among the plurality of periods of time (in the above-described embodiment, four rotation periods are provided) of the intermittent transport of the medium (sheet S), during the first rotation period of the upstream transport roller (feed roller 22) and the downstream transport roller (conveying roller 23), the control portion (controller 60) of the medium transporting apparatus (printer 1) of the present embodiment controls the amount of transport of the sheet S by the feed roller 22 so as to be greater than the amount of transport of the sheet S by the conveying roller 23. During the second and later rotation periods, the controller 60 controls the amount of transport of the sheet S by the feed roller 22 so as to be the same as the amount of transport of the sheet S by the conveying roller 23. With this, it is possible to properly transport the sheet S on an intermittent basis. This will be described in detail below.

As described in the Related Art section, for smooth intermittent transport of the sheet S, the feed roller 22 and the conveying roller 23 transport the sheet S on an intermittent basis while loosening the sheet S. Inside the printer 1, there is a mechanism, in which in order to loosen the sheet S, during rotation of the feed roller 22 and the conveying roller 23, the amount of transport of the sheet S by the feed roller 22 (i.e., the amount of rotation of the feed roller 22) is controlled so as to be greater than the amount of transport of the sheet S by the conveying roller 23 (i.e., the amount of rotation of the conveying roller 23).

However, when the printer 1 continuously starts and interrupts the rotation of the feed roller 22 and the conveying roller 23 over a plurality of periods of time in the state in which the amount of transport of the sheet S by the feed roller 22 is greater than the amount of transport of the sheet S by the conveying roller 23, the amount of looseness of the sheet S increases accumulatively. If the amount of looseness of the sheet S accumulates excessively, the sheet S makes contact with other members (for example, the sheet detecting sensor 26 or the main body frame 28 shown in FIG. 4A) within the printer 1 other than the feed roller 22 and the conveying roller 23, thereby damaging the members or the sheet S or generating abnormal sound at the time of the contact. In this way, when the amount of looseness of the sheet S is excessively large, the sheet S is not properly transported on an intermittent basis.

To the contrary, in the present embodiment, the controller 60 controls in the following manner to solve the above-described problems. That is, as shown in FIG. 5, during the first rotation period of the feed roller 22 and the conveying roller 23, the controller 60 controls the amount of transport of the sheet S by the feed roller 22 so as to be greater than the amount of transport of the sheet S by the conveying roller 23 (steps S102 and S104). During the second and later rotation periods of the feed roller 22 and the conveying roller 23, the controller 60 controls the amount of transport of the sheet S by the feed roller 22 so as to be the same as the amount of transport of the sheet S by the conveying roller 23 (steps S108 and S110).

In such a case, during the first rotation period, since the amount of transport of the sheet S by the feed roller 22 is greater than the amount of transport of the sheet S of the conveying roller 23, the sheet S is securely loosened when the first rotation period ends. During the second and later rotation periods, since the amount of transport of the sheet S by the feed roller 22 is the same as the amount of transport of the sheet of the conveying roller 23, it is possible to prevent the amount of looseness of the sheet S from increasing accumulatively with the rotation of the feed roller 22 and the conveying roller 23 while maintaining the amount of looseness of the sheet S when the first rotation period ends. For this reason, it is possible to prevent the sheet S from making contact with other members, which may be caused when the amount of looseness of the sheet S accumulates excessively. As a result, the sheet S is properly transported on an intermittent basis.

### Other Embodiments

Although the medium transporting apparatus of the invention has been described with reference to the exemplary embodiments, it should be understood that the invention is not limited to such embodiments. Various shapes or combinations of respective constituent elements illustrated in the above-described embodiments are merely examples, and various changes may be made depending on design requirements or the like without departing from the spirit or scope of the invention.

In the above-described embodiment, as an example of the medium transport apparatus, the printing apparatus (printer 1) shown in FIG. 2 that prints images on the sheet S has been described. However, the invention can be applied to any apparatus if the apparatus includes the upstream transport roller (feed roller 22) and the downstream transport roller (conveying roller 23) for transporting the sheet S on an intermittent basis by the collective rotation of the rollers.

However, regarding the configuration of printing images on the sheet S, the image quality deteriorates when the intermittent transport of the sheet S is improperly performed. Therefore, the above-described embodiment is preferable because the above-described rotation control of the feed roller 22 and the conveying roller 23 can more effectively provide the advantage that the intermittent transport of the sheet S is properly performed.

Although in the above-described embodiment, as shown in FIGS. 5 and 6, during the second and later rotation periods of the feed roller 22 and the conveying roller 23, the controller 60 starts the rotation of the conveying roller 23 before the feed roller 22 starts rotating (step S108 of FIG. 5), the invention is not limited to this. For example, during the second and later rotation periods, the controller 60 may start the rotation of the feed roller 22 before the conveying roller 23 starts rotating.

As will be described later, however, the above-described embodiment is preferable because the intermittent transport of the sheet S is more effectively performed. When the rotation of the feed roller 22 disposed upstream in the transport direction is started first, the amount of looseness of the sheet S between the feed roller 22 and the conveying roller 23 increased until the conveying roller 23 starts rotating. As a result of the increase in the amount of looseness, the sheet S may make contact with other members (the sheet detecting sensor 26 or the main body frame 28) other than the feed roller 22 and the conveying roller 23. On the other hand, when the rotation of the conveying roller 23 disposed downstream in the transport direction is started first, the amount of looseness of the sheet S between the feed roller 22 and the conveying roller 23 decreases until the feed roller 22 starts rotating. Therefore, the above-described problems are not caused. For this reason, the above-described embodiment is preferable because the intermittent transport of the sheet S is more effectively performed.

Although in the above-described embodiment, as shown in FIGS. 5 and 6, during the second and later rotation periods of the feed roller 22 and the conveying roller 23, the controller 60 stops the rotation of the feed roller 22 after the conveying roller 23 stops rotating (step S110 of FIG. 5), the invention is not limited to this. For example, during the second and later rotation periods, the controller 60 may stop the rotation of the conveying roller 23 after the feed roller 22 stops rotating.

As will be described later, however, the above-described embodiment is preferable because it is possible to prevent or suppress generation of abnormal sound resulting from the sheet S pulled by the conveying roller 23. Between the feed roller 22 and the conveying roller 23 in the transport direction, the feed roller 22 transports the sheet S in a manner that the sheet S is pushed by the pair of rollers. On the other hand, the conveying roller 23 transports the sheet S in a manner that the sheet S is pulled by the pair of rollers. In such a case, if the rotation of the conveying roller 23 stops after the feed roller 22 stops rotating, when the conveying roller 23 stops rotating, it is likely that an abnormal sound is generated resulting from the sheet S pulled by the conveying roller 23. On the other hand, when the rotation of the feed roller 22 stops after the conveying roller 23 stops rotating, the sheet S is not pulled by the conveying roller 23 because the rotation of the conveying roller 23 has been interrupted. Therefore, it is not likely that the abnormal sound is generated. For this reason, the above-described embodiment is preferable because it is possible to prevent or suppress generation of abnormal sound resulting from the sheet S pulled by the conveying roller 23.

Although in the above-described embodiment, as shown in FIGS. 5 and 6, during the first rotation period of the feed roller 22 and the conveying roller 23, the controller 60 starts the rotation of the feed roller 22 before the conveying roller 23 starts rotating (step S102 of FIG. 5), and stops the rotation of the feed roller 22 after the conveying roller 23 stops rotating (step S104), the invention is not limited to this. For example, during the first rotation period, the controller 60 may stop the rotation of the conveying roller 23 after the feed roller 22 stops rotating.

However, the above-described embodiment is preferable because it is possible to securely loosen the sheet S during the first rotation period and to prevent or suppress generation of abnormal sound resulting from the sheet S pulled by the conveying roller 23.

What is claimed is:

1. A medium transporting apparatus for transporting a medium in a transport direction, comprising:
an upstream transport roller and a downstream transport roller, provided respectively upstream and downstream in the transport direction, for transporting the medium on an intermittent basis by the collective rotation of the rollers; and
a control portion for starting and interrupting the rotation of the upstream transport roller and the downstream transport roller in an alternating manner over a plurality of periods of time during the intermittent transport of the medium,
wherein during the first rotation period of the upstream transport roller and the downstream transport roller, the control portion controls the amount of transport of the medium by the upstream transport roller so as to be greater than the amount of transport of the medium by the downstream transport roller, and
wherein during the second and later rotation periods of the upstream transport roller and the downstream transport roller, the control portion controls the amount of transport of the medium by the upstream transport roller so as to be the same as the amount of transport of the medium by the downstream transport roller.

2. The medium transporting apparatus according to claim 1, wherein during the second and later rotation periods of the upstream transport roller and the downstream transport roller, the control portion starts the rotation of the upstream transport roller before the downstream transport roller starts rotating.

3. The medium transporting apparatus according to claim 1, wherein during the second and later rotation periods of the upstream transport roller and the downstream transport roller, the control portion stops the rotation of the upstream transport roller after the downstream transport roller stops rotating.

4. The medium transporting apparatus according to claim 1, wherein during the first rotation period of the upstream transport roller and the downstream transport roller, the control portion starts the rotation of the upstream transport roller before the downstream transport roller starts rotating and stops the rotation of the upstream transport roller after the downstream transport roller stops rotating.

5. The medium transporting apparatus according to claim 1, wherein the medium transporting apparatus is a printing apparatus that prints images on the medium, the printing apparatus comprising,
an ink ejecting portion for ejecting ink onto the medium, provided on the downstream side of the downstream transport roller in the transport direction so as to be opposed to the medium being transported by the upstream transport roller and the downstream transport roller on an intermittent basis.

6. A medium transporting method, in which when an upstream transport roller and a downstream transport roller, provided respectively upstream and downstream in a transport direction, transport a medium on an intermittent basis by the collective rotation of the rollers, the rotation of the downstream transport roller and the upstream transport roller is started and interrupted in an alternating manner over a plurality of periods of time, the method comprising:
during the first rotation period of the upstream transport roller and the downstream transport roller, controlling the amount of transport of the medium by the upstream transport roller so as to be greater than the amount of transport of the medium by the downstream transport roller; and
during the second and later rotation periods of the upstream transport roller and the downstream transport roller, controlling the amount of transport of the medium by the upstream transport roller so as to be the same as the amount of transport of the medium by the downstream transport roller.
